(19) United States
(12) Patent Application Publication
(10) Pub. No.: US 2006/0261633 A1
(43) Pub. Date: Nov. 23, 2006

(54) Automobile door assemblies

(76) Inventor: Jay Winborn, Berkley, MI (US)

Correspondence Address: BUTZEL LONG, 350 SOUTH MAIN STREET, SUITE 300, ANN ARBOR, MI, 48104, US

(21) Appl. No.: 11/332,107

(22) Filed: Jan. 13, 2006

Related U.S. Application Data
(63) Continuation-in-part of application No. 11/134,942, filed on May 23, 2005.

(51) Int. Cl. B60J 5/00

(52) U.S. Cl. 296/146.7

(57) ABSTRACT

A barrier panel for vehicle door assemblies that in provided with snap attachment structures that extend outward from an outboard side thereof. The snap attachment structures are configured to engage various structures, including notches, tabs and/or individual discrete holes provided in the inboard surface of a door panel.

### RELATED APPLICATIONS

This application is a Continuation-In-Part of U.S. patent application Ser. No. 11/134,942, filed May 23, 2005 to which priority is claimed under 35 U.S.C. §120 and of which the entire specification is hereby expressly incorporated by reference.

### TECHNICAL FIELD

The present invention relates to vehicle door water shield barriers which prevent the ingress of water, sound, dust and air into a vehicle passenger compartment. More particularly, the present invention relates to water seal or barrier panels for vehicle door assemblies that include snap attachment structures that are configured to align and secure the water seal or barrier panels directly to door panels.

### BACKGROUND ART

Automobile door assemblies generally include an exterior metal panel skin that is joined to an inner wall panel along the respective edges of the panels. Together, the exterior panel and the inner wall panel form a cavity within which the door window may be lowered. This cavity may also contain window regulating equipment, door locks, sound speakers, air bag systems, and the like. The inner wall panel is covered with a rigid or semi-rigid interior trim panel formed of a cloth-like or plastic trim material which serves as the interior passenger compartment door panel.

Door panel assemblies are susceptible to the ingress of water which can enter into door cavities through the openings through which the door windows slide. Holes are generally formed in the bottom of door panel assemblies to allow any water that enters the door cavities to drain out. However, as water enters door cavities and runs down along the inner wall panel toward the drain holes, it can seep into and through the interior trim panel unless a barrier of some type is provided in the assembly.

In order to protect the interior trim panel from becoming wet and possibly stained or otherwise damaged, it is common to attach a panel liner over the inner wall panel beneath the interior trim panel. Such panel liners are often made of a treated paper material or can comprise a thin plastic film. The panel liner functions to deflect any water entering the door cavity so that the water runs down the liner to the bottom of the door cavity without contacting the interior trim panel.

Liners used in door panel assemblies are typically provided with beads of adhesive which are primarily provided to create a water tight seal between the liners and the adjacent door panels. In order to protect the adhesive beads, a release sheet is secured to the liners over the adhesive beads. The release sheet has to be removed when the liner is applied to an inner wall panel of a door.

Inner trim panels of door assemblies together with liners are typically attached to door panels by a plurality of push-in fasteners that are commonly referred to as “Christmas trees.” The push-in fasteners extend outward from the outboard side of the inner trim panels and are spaced apart adjacent the peripheral edge of the inner trim panels. The liners are provided with through-holes that are aligned with the push-in fasteners and the inboard surface of the door panels include through-holes which are aligned to receive the push-in fasteners provided on the inner trim panels. The inner trim panels are attached to the door panels by aligning and pushing the push-in fasteners on the inner trim panels into the through-holes in the door panels. The liners are positioned between the inner trim panels and door panels and held in position by the push-in fasteners. If, while aligning the inner trim panels and liners with the door panels, the adhesive bead(s) contact the door panel with the parts misaligned, it can become necessary to remove the liner from contact with the door panel and realign the inner trim panels and liners with the door panels.

The present invention is directed to barrier panel for vehicle door panel assemblies that include snap attachment structures that are used for aligning and securing the barrier panels onto door panels.

### DISCLOSURE OF THE INVENTION

According to various features, characteristics and embodiments of the present invention which will become apparent as the description thereof proceeds, the present invention provides a barrier liner for a vehicle door assembly which includes:

a sheet of substantially water-impermeable material that is substantially complimentarily shaped to the door panel having an inboard surface and an outboard surface; and

a plurality of snap attachment structures that extend outward from the outboard surface of the sheet of substantially water-impermeable material and which are configured to engage at least one of tabs, notches or individual discrete openings formed in an inboard surface of a door panel.

The present invention further provides a vehicle door assembly that includes:

a door panel having and inboard side and an outboard and at least one of tabs, notches or individual discrete openings formed in an inboard surface of a door panel;

a barrier liner that comprises:
i) a sheet of substantially water-impermeable material that is substantially complimentarily shaped to the door panel having an inboard surface and an outboard surface; and
ii) a plurality of snap attachment structures that extend outward from the outboard surface of the sheet of substantially water-impermeable material and which are configured to engage at least one of said tabs, notches or individual discrete openings formed in the inboard surface of the door panel; and

an interior trim panel.

### BRIEF DESCRIPTION OF DRAWINGS

The present invention will be described with reference to the attached drawings which are given as non-limiting examples only, in which:

FIG. 1A is an elevational view of a door assembly showing a barrier panel according to one embodiment of the present invention in that is provided with engaging structures.

FIG. 1B is a sectional view of the door assembly of FIG. 1A taken along section lines 1B-1B.

FIG. 1C is an enlarged view of the encircled portion of the door assembly illustrated in FIG. 1B.

FIG. 2 is a cross-sectional view of an engaging structure according to one embodiment of the present invention.

FIG. 3A is an elevational view of a door panel according to another embodiment of the present invention.

FIG. 3B is an elevational view of the door panel of FIG. 3A having a barrier panel attached to the inner surface thereof.

FIG. 3C is a sectional view taken along sectional lines 3C-3C in FIG. 3B.

FIG. 3D is a sectional view taken along sectional lines 3D-3D in FIG. 3B.

FIG. 4A is an elevational view of a door panel according to another embodiment of the present invention.

FIG. 4B is an outboard elevational view of the door panel of FIG. 4A having a barrier panel attached to the inner surface thereof.

FIG. 4C is an inboard elevational view of the door panel of FIG. 4A having a barrier panel attached to the inner surface thereof.

FIG. 4D is a sectional view taken along sectional lines 4D-4D in FIG. 4C.

FIG. 4E is a sectional view taken along sectional lines 4E-4E in FIG. 4C.

FIG. 5A is an elevational view of a door panel according to another embodiment of the present invention.

FIG. 5B is an outboard elevational view of the door panel of FIG. 5A having a barrier panel attached to the inner surface thereof.

FIG. 5C is an inboard elevational view of the door panel of FIG. 5A having a barrier panel attached to the inner surface thereof.

FIG. 5D is a sectional view taken along sectional lines 5B-5B in FIG. 5B.

### BEST MODE FOR CARRYING OUT THE INVENTION

The present invention is directed to water seals or barrier panels for vehicle door assemblies that include engaging structures that are formed integrally on the barrier panels by various molding techniques using molding apparatuses that are described herein. Reference herein to door panels encompasses both passenger doors, cargo doors and other closures which are susceptible to water leakage or might require thermal and/or acoustic insulation.

The engaging structures are formed so as to extend outward from an outboard side of the barrier panels and are configured with over-hanging or under cut edges that engage the edge or edges of openings formed in the inboard side of a door panel. The over-hanging or under cut edges can be formed from a variety of molding apparatuses.

In addition to securing a door panel to a door panel, the engaging structures assist in aligning the barrier panel with the door panel by aligning the engaging structure, which protrude outward, with the contour or shape of the opening(s) formed in the inboard side of the door panel.

The barrier panels can be molded form any suitable material such as, for example, polyethylene, polystyrene, ABS plastics, polypropylene, thermal plastics, foamable plastics, etc.

Features and characteristics of the present invention will be hereafter described with reference to the attached drawings which are provided as non-limiting examples only. Throughout the drawings, similar reference numerals are used to identify common elements when possible in order to simplify the description.

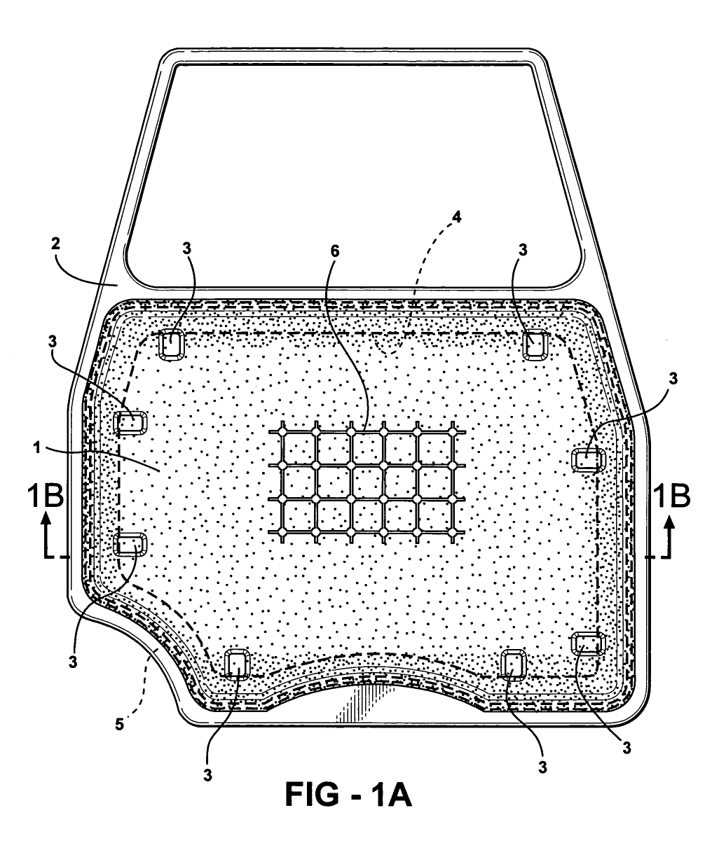

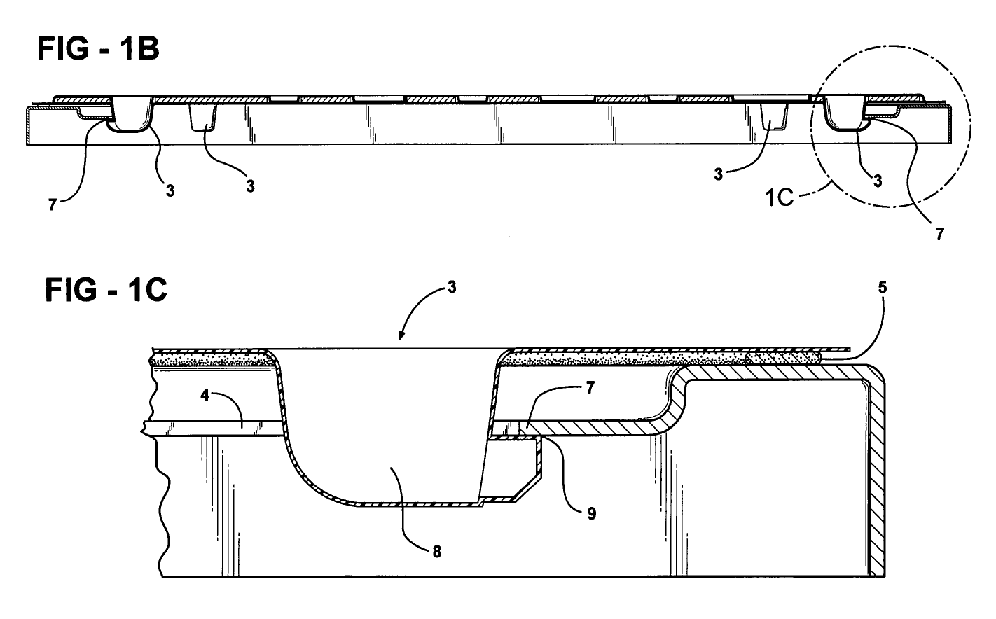

FIG. 1A is an elevational view of a barrier panel according to one embodiment of the present invention that is provide with engagement structures. The barrier panel which can comprise a single sheet or two or more sheets that are bonded together is generally identified by reference numeral 1 and is depicted as being attached to an exterior door panel 2. The barrier panel 1 includes a plurality of engaging structures 3 that are spaced apart around the exterior edges of the barrier panel 1. As shown in broken lines, the exterior door panel 2 includes an opening 4 into which the engaging structures 3 are received so as to align the barrier panel 1 with the exterior door panel 2 and secure the barrier panel 1 to the exterior door panel 2. Also shown in broken lines is a sealing element 5 that extends along the periphery of the barrier panel 1 so as to be positioned between the barrier panel 1 and the exterior door panel 2. The sealing element 5 can comprises a bead or beads of any conventional sealant/adhesive material or a compressible sealing element that can be molded into the outboard surface of the barrier panel 1.

The barrier panel 1 is depicted in FIG. 1A as having reinforcing structure in the central portion thereof generally shown as a grid structure 6 that can, for example be channels formed in one side of the barrier panel 1 so that the walls of the channels structurally reinforce the central portion of the barrier panel 1. Alternatively, when the barrier panel 1 is made from two or more sheets, the grid structure 6 represents channels in one or more of the individual sheets along the bottoms of which adjacent sheets are bonded together to structurally reinforce the barrier panel 1. Of course, in addition to a grid structure 6 that is illustrated, discrete channels, depressions, indentations, etc. could be used. When the barrier panel 1 comprises two or more sheets that are bonded together, areas in the space between adjacent sheets can be hollow or can contain or be filled with acoustic and/or thermal insulation materials such as noise absorbing materials or materials with low thermal conductivity.

FIG. 1B is a cross-sectional view of FIG. 1A taken along sectional lines 1B-1B. FIG. 1B best shows the manner in which the engaging structures 3 extend into the opening 4 provided in the inboard side of the exterior door panel 2 so as to engage the edge 7 of the opening 4. As can be understood from FIGS. 1A and 1B the number and alignment of the engaging structures 3 can be varied as desired to accommodate a given door assembly, taking into consideration size, shape, etc. In some embodiments the door panel 2 may have several smaller openings rather than one opening 4 as shown. In such a case engagement structures 3 can be provided and aligned to engage the edges of some or all the openings.

FIG. 1C is an enlarged view of the encircled portion “C” of the door assembly illustrated in FIG. 1B. As can be seen best in FIG. 1C, the engagement structure 3 includes a base portion 8 and a molded under-cut or overhanging edge 9 (shown upside down) that engages the peripheral edge 7 of the opening 4 formed in the exterior door panel 2. This molded under-cut or overhanging edge 9 can have various shapes as will be understood as the description of the invention proceeds. FIG. 1C illustrates one configuration in which a bead of an adhesive and/or sealant material 5 is provided between the peripheral edge of the barrier panel 1 and the door panel 2 to provide a seal which prevents water or moisture from seeping therebetween.

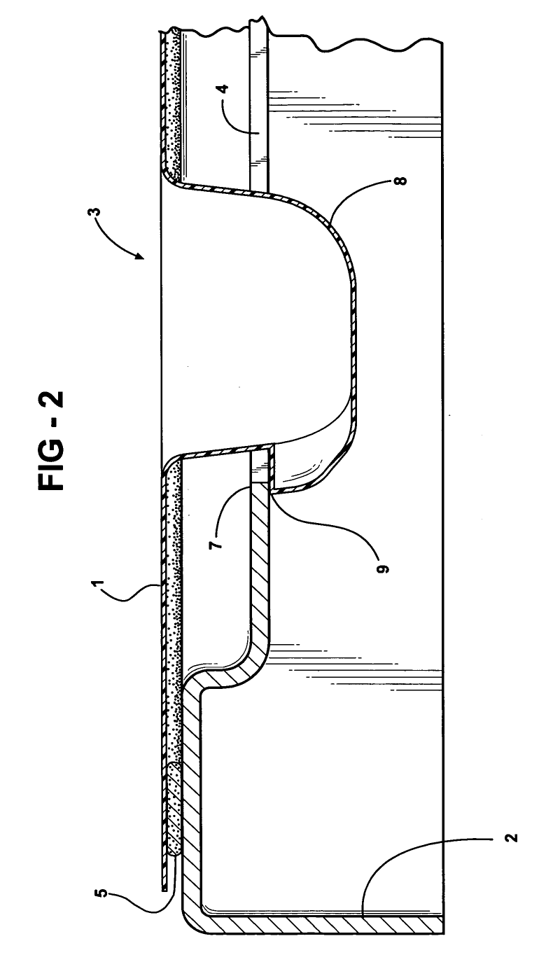

FIG. 2 is a cross-sectional view of an engaging structure according to one embodiment of the present invention. The engagement structure 3 includes a base portion 8 that is generally hollow and formed as a depression or pocket that extends from the inboard surface of the barrier panel 1 inward toward the outboard surface. Near the bottom of the base portion 8 an under-cut or overhanging edge 9 (shown upside down) is provided which, as shown, is configured to engage the peripheral edge 7 of the opening 4 formed in the exterior door panel 2. In some embodiments, the engagement structures 3 could have base portions 8 that are elongated and configured, e.g. curved or angled, to be complementary to the shape of the edges of an opening 4 formed in a door panel 1 and could be provided with one or more under-cut or overhanging edge portions 9. For example, an engaging structure 3 having a right angled shape could be provided to align the barrier panel 1 with a corner of an opening 4 formed in a door panel 2 and could be provided with engaging structures 3 that engage the edges 7 of the opening 4 on either side of the corner.

The engaging structures 3 discussed and described above are configured to engage an edge of an opening in a door panel. In alternative embodiments, the door panels can be provided with tabs and/or notches and/or holes that are configured to cooperate with snap attachment structures formed or provided on the barrier panels.

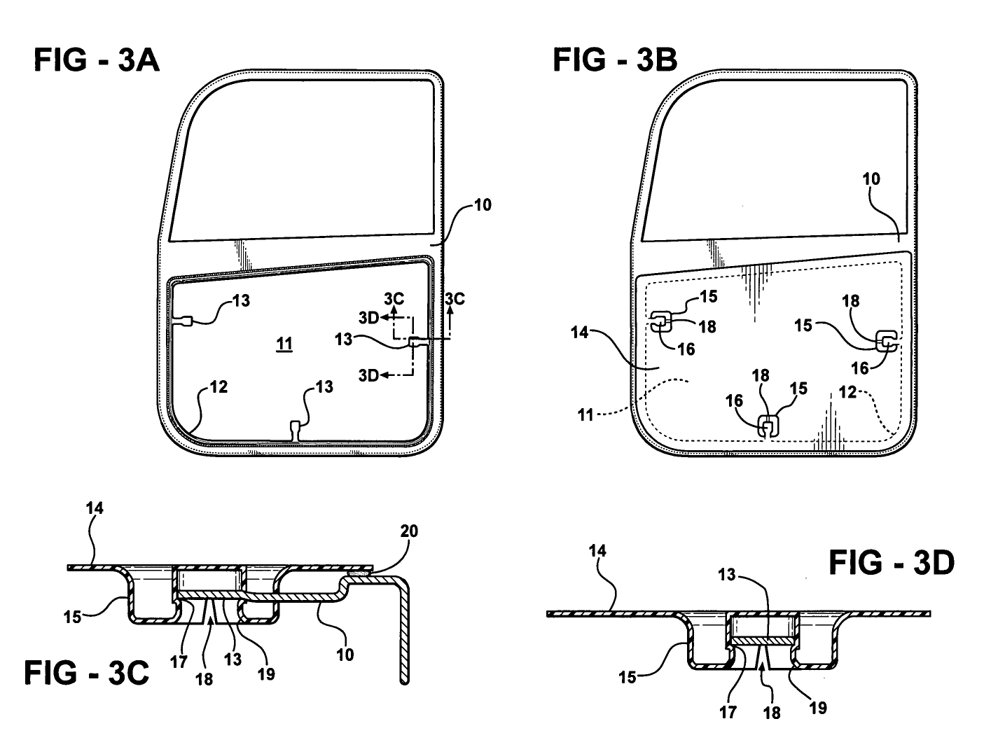

FIG. 3A is an elevational view of a door panel according to another embodiment of the present invention. In FIG. 3A the inner or inboard surface of the door panel 10 is depicted as including an opening 11 that has a peripheral edge 12. Along the peripheral edge 12 of opening 11 a plurality of tabs 13 are formed which extend inwardly from the peripheral edge 12. Such tabs 13 can be formed when the opening 11 is formed in the door panel 10, or added on after the opening 11 is formed, or provided or formed by any convenient manner.

FIG. 3B is an elevational view of the door panel of FIG. 3A having a barrier panel attached to the inner surface thereof. The inner or inboard surface of the barrier panel 14 is shown in FIG. 3B. The barrier panel 14 includes snap attachment structures 15 that are configured to receive the tabs 13 of the door panel 10. In the case of the particular tabs 13 provided on the door panel 10, the snap attachment structures 15 have a generally annular configuration and protrude inwardly (or in the outboard direction) as shown n FIG. 3B. At least the center of the generally annular configuration is complementarily to the shape of the tabs 13 as depicted. The tabs 13 are received in the centers 16 of the snap attachment structures 15 and engage a slight ridge 17 formed on the inwardly protruding structure of the snap attachment structures 15 as depicted. The snap attachment structures 15 are provided with one or more expansion slots 18 which allow the generally annular configurations to expand and open up to receive the tabs 13 therein when the barrier panel 14 is pushed against the door panel 10. The edge 19 of the opening at the center 16 of the snap attachment structures 15 is beveled or inclined so as to allow the generally annular configurations to expand as the tabs 13 slide along the beveled or inclined edges 19.

FIG. 3C is a sectional view taken along sectional lines 3C-3C in FIG. 3B. FIG. 3D is a sectional view taken along sectional lines 3D-3D in FIG. 3B. FIGS. 3C and 3D depict how the tab 13 is received in the center 16 of the generally annular configuration of the snap attachment structure 15 and particularly how the tab 13 is caught by ridge 17 formed on the inwardly protruding structure of the snap attachment structure 15. In FIG. 3D the periphery of the barrier panel 14 that extends over the door panel 10 outward from opening 11 is provide with a bead of adhesive/sealant 20.

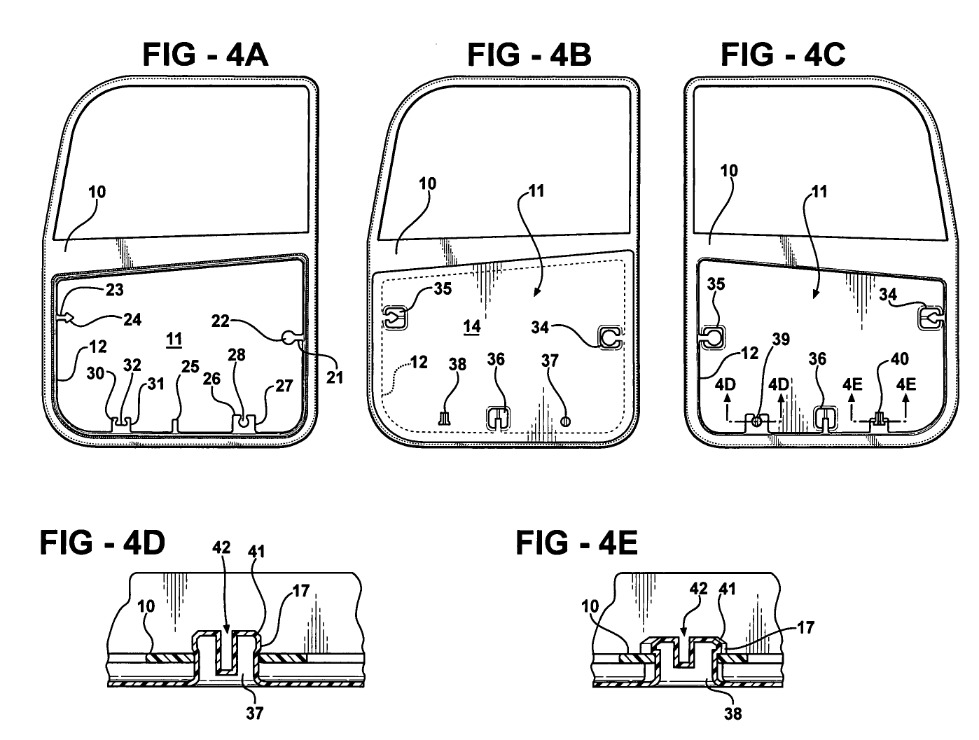

FIG. 4A is an elevational view of a door panel according to another embodiment of the present invention. The door panel in FIG. 4A is provided with examples of different shaped tab structures for illustrative purposes, it being understood that the depicted tab structures are non-limiting examples and that tab structures having further shapes can be used.

Tab 21 includes a generally circular portion 22 that extends into the opening 11 in door panel 10 from the peripheral edge 12 of the opening 11. Tab 23 includes a generally triangular portion 24 that extends into the opening 11 from the peripheral edge 12 of the opening 11. Tab 25 has a substantially rectangular shape that extends into the opening 11 from the peripheral edge 12 of the opening 11. From tabs 21, 23 and 25 it will be understood that in general the tabs can have any shape, including circular, oval, rectangular, square, polygonal or any combination thereof or combination of linear and/or curved shapes.

Tab 26 comprises a rectangular portion 27 that extends into the opening 11 from the peripheral edge 12 of the opening 11 and a notch 28 formed in the end of the rectangular portion 27. The notch 28 has a circular shape as shown.

Tab 30 also comprises a rectangular portion 31 that extends into the opening 11 from the peripheral edge 12 of the opening 11 and a notch 32 formed in the end of the rectangular portion 31. The notch 32 formed in tab 30 has a dovetail shape as shown. It is to be understood that the notches can have any shape, including circular, oval, rectangular, square, polygonal, or any combination thereof or combination of linear and/or curved shapes.

FIG. 4B is an elevational view of the door panel of FIG. 4A having a barrier panel attached to the inner surface thereof. The outboard surface of the barrier panel 14 is shown in FIG. 4B. FIG. 4C is an elevational view of the door panel of FIG. 4A having a barrier panel attached to the inner surface thereof. The inboard surface of the barrier panel 14 is shown in FIG. 4C. The barrier panel 14 includes snap attachment structures that are either configured to receive the tabs of the door panel 10 or to be received in the notches of the tabs of the door panel 10.

Snap attachment structures 34, 35 and 36 are similar to the snap attachment structure 15 of FIGS. 3A-3D, but have centers which are configured to be complementary shaped to the circular portion of tab 21, the triangular portion of tab 23 and the rectangular portion of tab 25 respectively. Snap attachment structures 34, 35 and 36 receive the tabs 21, 23 and 25 in their centers so that the tabs 21, 23 and 25 are caught by ridges 17 that are formed on the inwardly protruding structure of the snap attachment structures 34, 25 and 36 similarly as described in reference to the embodiment of the invention shown in FIGS. 3A-3D.

Snap attachments 37 and 38 have portions 39 and 40 that protrude inwardly (or in the outboard direction) as shown in FIG. 4C, which portions 39 and 40 are configured to snap fit into notches 28 and 32 formed in tabs 26 and 30. That is, snap attachment 37 has a portion 39 that protrudes inwardly (or in the outboard direction) as shown in FIG. 4C, which portion 39 has a circular cross sectional shape and snap attachment 38 has a portion 40 that protrudes inwardly (or in the outboard direction) as shown in FIG. 4C, which portion 40 has a dovetailed cross sectional shape.

FIG. 4D is a sectional view taken along sectional lines 4D-4D in FIG. 4C. FIG. 4E is a sectional view taken along sectional lines 4E-4E in FIG. 4C. FIGS. 4D and 4E depict how the protruding portions 39 and 40 of snap attachment structures 37 and 38 are received in notches 28 and 32 of tabs 26 and 30. As shown, the protruding portions 39 and 40 of snap attachment structures 37 and 38 have outwardly extending ridge portions 17 that engage the outboard surfaces of tabs 26 and 30. In addition, the outboard edges 41 of the protruding portions 39 and 40 are beveled or inclined so as to allow protruding portions 39 and 40 to slide into the notches 28 and 32. The protruding portions 39 and 40 also include one or more compression notches 42 formed in the outboard faces which allow the diameter at the ends of the protruding portions 39 and 40 to become reduced in size as the protruding portions 39 and 40 slide into the notches 28 and 32. That is, the width of the gap of the compression notches 42 becomes reduced as the snap attachment structures 37 and 38 are pushed into the notches 28 and 32 of tabs 26 and 30. Once the ridge portions 17 of the protruding portions 39 and 40 pass through notches 28 and 32 the compression notches 42 expand to affect a snap fit of the snap attachment structures 37 and 38 with the tabs 26 and 30.

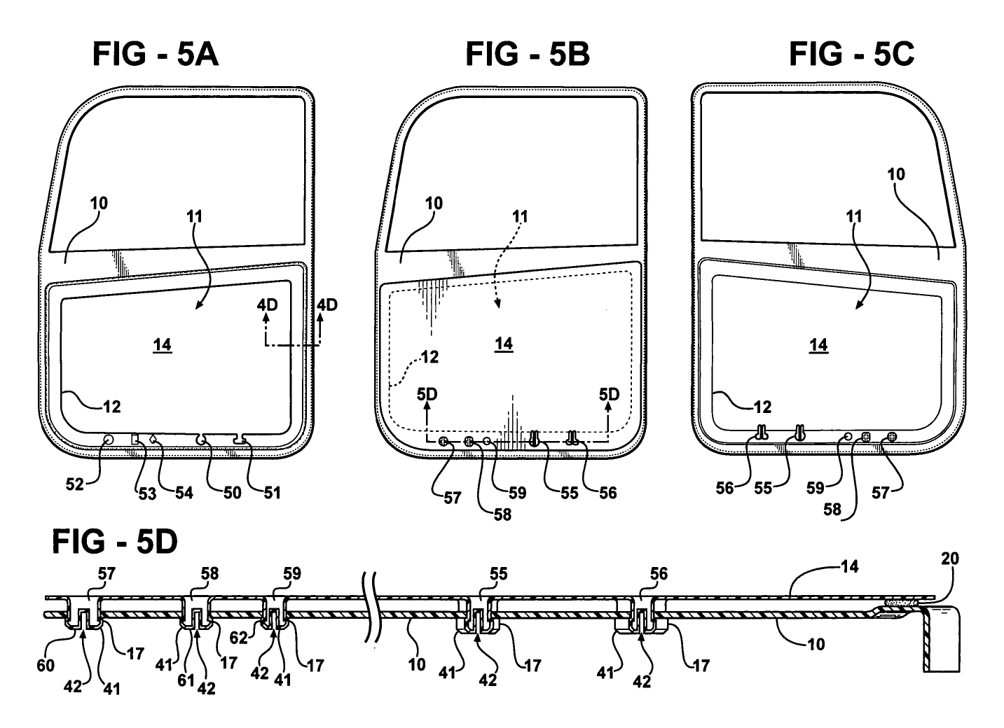

FIG. 5A is an elevational view of a door panel according to another embodiment of the present invention. The door panel 10 in FIG. 5A is provided with examples of different shaped holes for illustrative purposes that are configured to receive snap attachment structures, it being understood that the depicted holes are non-limiting examples and that holes having further shapes can be used.

Holes 50 and 51 have portions that intersect opening 11 formed in door panel 10. Hole 50 has a circular shape and hole 51 has a dovetailed shape. Holes 52, 53 and 54 do not intersect opening 11. Hole 52 as a circular shape, hole 53 has a rectangular shape and hole 54 has a diamond shape. It is to be understood that any of holes 50, 51, 52, 53 and 54 could have any shape, including circular, oval, rectangular, square, polygonal or any combination thereof or combination of linear and/or curved shapes.

FIG. 5B is an elevational view of the door panel of FIG. 5A having a barrier panel attached to the inner surface thereof. The outboard surface of the barrier panel 14 is shown in FIG. 5B. FIG. 5C is an elevational view of the door panel 10 of FIG. 5A having a barrier panel attached to the inner surface thereof. The inboard surface of the barrier panel 14 is shown in FIG. 5C. The barrier panel 14 includes snap attachment structures that are configured to be received in holes 50, 51, 52, 53 and 54 formed in door panel 14.

The snap attachment structures 55 and 56 are substantially similar to snap attachment structures 37 and 38 discussed above with reference to FIGS. 4A-4E, since they are similarly shaped and the only difference is that the notches 28 and 32 in FIGS. 4A-4E are formed in tabs 26 and 30 and the holes 55 and 56 of FIGS. 5A-5D are formed in the inner surface of the door panel 10 so as to intersect opening 11. That is, only the position of snap attachment structures 55 and 56 shown in FIGS. 5A-5D and snap attachment structures 37 and 38 discussed above with reference to FIGS. 4A-4E differ. Accordingly, reference to the above discussion of snap attachment structures 37 and 38 is made herein for a description of snap attachment structures 55 and 56.

FIG. 5D is a sectional view taken along sectional lines B-5B in FIG. 5B. Snap attachment structures 57, 58 and 59 having protruding portions 60, 61 and 62 that are complementarily shaped to holes 52, 53 and 54. That is, protruding portion 60 of snap attachment structure 57 has a circular cross sectional shape, protruding portion 61 of snap attachment structure 58 has a rectangular cross sectional shape and protruding portion 62 of snap attachment structure 59 has a diamond cross sectional shape.

The protruding portions 60, 61 and 62 of snap attachments 57, 58 and 59 are configured to snap fit into holes 52, 53 and 54. FIG. 5D depicts how the protruding portions 60, 61, and 62 of snap attachment structures 57, 58 and 59 are received in holes 52, 53 and 54. As shown, the protruding portions 60, 61 and 62 of snap attachment structures 57, 58 and 59 have outwardly extending ridge portions 17 that engage the outboard surface of door panel 10. In addition, the outboard edges 41 of the protruding portions 60, 61 and 62 are beveled or inclined so as to allow protruding portions 60, 61 and 62 to slide into holes 52, 53 and 54. The protruding portions 60, 61 and 62 also include one or more compression notches 42 formed in the outboard faces which allow the diameter at the ends of the protruding portions 60, 61 and 62 to become reduced in size as the protruding portions 60, 61 and 62 slide into holes 52, 53 and 54. That is, the width of the gap of the compression notches 42 becomes reduced as the snap attachments 57, 58 and 59 are pushed into holes 52, 53 and 54. Once the ridge portions 17 of the protruding portions 60, 61 and 62 pass through holes 52, 53 and 54 the compression notches 42 expand to affect a snap fit of the snap attachment structures 57, 58 and 59 with the holes 52, 53 and 54.

It is to be understood that any combination of the snap attachment structures described and discussed herein could be used in a door panel assembly. Likewise, the snap attachment structures of a door panel assembly could all be similar rather than a combination of different snap attachment structures.

The snap attachment structures can be made by injection molding processes, thermal molding processes, rotational molding, or any suitable molding process.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and as set forth in the attached claims.

What is claimed is:

1. A barrier liner for a vehicle door assembly which comprises:
a sheet of substantially water-impermeable material that is substantially complimentarily shaped to the door panel having an inboard surface and an outboard surface; and
a plurality of snap attachment structures that extend outward from the outboard surface of the sheet of substantially water-impermeable material and which are configured to engage at least one of tabs, notches or individual discrete openings formed in an inboard surface of a door panel.

2. The barrier liner for a vehicle door assembly according to claim 1, wherein the plurality of snap attachment structures are configured to engage at least one of tabs and notches formed in an inboard surface of a door panel.

3. The barrier liner for a vehicle door assembly according to claim 1, wherein the plurality of snap attachments comprise ridges that are configured to engage an outboard surface of a door panel.

4. The barrier liner for a vehicle door assembly according to claim 1, wherein the plurality of snap attachments comprise at least one compression notch.

5. The barrier liner for a vehicle door assembly according to claim 1, wherein the plurality of snap attachments comprise at least one expansion slot.

6. The barrier liner for a vehicle door assembly according to claim 1, wherein the plurality of snap attachments comprise substantially annular structures.

7. The barrier liner for a vehicle door assembly according to claim 1, wherein the plurality of snap attachments comprise geometric cross sectional shapes.

8. A vehicle door assembly that comprises:
a door panel having and inboard side and an outboard and at least one of tabs, notches or individual discrete openings formed in an inboard surface of a door panel;
a barrier liner that comprises:
i) a sheet of substantially water-impermeable material that is substantially complimentarily shaped to the door panel having an inboard surface and an outboard surface; and
ii) a plurality of snap attachment structures that extend outward from the outboard surface of the sheet of substantially water-impermeable material and which are configured to engage at least one of said tabs, notches or individual discrete openings formed in the inboard surface of the door panel; and
an interior trim panel.

9. A vehicle door assembly according to claim 8, wherein one of tabs and notches are formed in the inboard surface of a door panel and the plurality of snap attachment structures are configured to engage at least one of tabs and notches formed in an inboard surface of a door panel.

10. A vehicle door assembly according to claim 9, wherein the one of tabs and notches are formed in the inboard surface of a door panel extend inward from the edge of a central opening formed in the inboard surface of the door panel.

11. A vehicle door assembly according to claim 8, wherein the plurality of snap attachments comprise ridges that are configured to engage an outboard surface of a door panel.

12. A vehicle door assembly according to claim 8, wherein the plurality of snap attachments comprise at least one compression notch.

13. A vehicle door assembly according to claim 8, wherein the plurality of snap attachments comprise at least one expansion slot.

14. A vehicle door assembly according to claim 8, wherein the plurality of snap attachments comprise substantially annular structures.

15. A vehicle door assembly according to claim 8, wherein the plurality of snap attachments comprise geometric cross sectional shapes.

16. A vehicle door assembly according to claim 8, wherein the at least one of tabs, notches or individual discrete openings formed in an inboard surface of a door panel comprises geometric shapes.

17. A vehicle door assembly according to claim 8, wherein the inboard side of the door panel comprises a central opening and the individual discrete openings comprise holes that partially intersect the central opening.

18. A vehicle door assembly according to claim 8, wherein the inboard side of the door panel comprises a central opening and the individual discrete openings comprise holes that do not intersect the central opening.

19. A vehicle door assembly according to claim 8, wherein the plurality of snap attachments comprise inclined leading outboard edges.
